(19) United States
(12) Patent Application Publication
(10) Pub. No.: US 2011/0188352 A1
(43) Pub. Date: Aug. 4, 2011

(54) Stepping motor control circuit and analogue electronic watch

(76) Inventor: Keishi Honmura, Chiba-shi (JP)

(21) Appl. No.: 12/931,413

(22) Filed: Jan. 28, 2011

(30) Foreign Application Priority Data
Feb. 3, 2010 (JP) 2010-022406

(51) Int. Cl. G04B 19/04; H02P 8/38

(52) U.S. Cl. 368/80; 318/696

(57) ABSTRACT

The invention provides a stepping motor control circuit including a rotation detecting circuit configured to detect an induced signal generated according to the state of rotation of a stepping motor, and a control unit configured to select any one of a plurality of drive pulses having different energy from each other according to the result of detection detected by the rotation detecting circuit and controls the drive of the stepping motor alternately with the selected drive pulses having different polarities from each other, wherein if the difference of detected time points of the induced signals generated when driving the stepping motor with the drive pulses having the same energy and different polarities is not shorter than a predetermined time, the control unit changes the drive pulse to a drive pulse having a larger energy than that of the above-described drive pulse and drives the stepping motor.

### BACKGROUND OF THE INVENTION

1. Field of the Invention

The present invention relates to a stepping motor control circuit and an analogue electronic watch using the stepping motor control circuit.

2. Related Art

In the related art, a two-pole PM (Permanent Magnet) stepping motor including a stator having a rotor storage hole and a positioning portion for determining a stop position of a rotor, the rotor disposed in the rotor storage hole, and a coil, and being configured to rotate the rotor by causing the stator to generate a magnetic flux by supplying alternating signals to the coil and stop the rotor at a position corresponding to the positioning portion is used in an electronic apparatus such as an analogue electronic watch.

As a low power consumption driving system of the two-pole PM stepping motor, a correction driving system for the stepping motor having a several types of main drive pulsed P1 which are responsible for driving the stepping motor in a normal condition and a correction drive pulse P2 having a larger driving energy than those of the respective types of the main drive pulses P1 and responsible for driving the stepping motor at the time of load fluctuations is now put into a practical use. A plurality of types of drive pulses having different drive energies from each other are prepared in advance as the main drive pulses P1, and the main drive pulses P1 are configured to be shifted in rank of the drive energy so that the energy is decreased or increased according to the rotation or non-rotation of the rotor to achieve driving with a minimum energy (see JP-B-61-15385).

The correction driving system is configured as follows. (1) The main drive pulse P1 is output to one pole O1 of a drive coil of the stepping motor, and an induced voltage generated in the coil due to oscillations of the rotor immediately after the output of the main drive pulse P1 is detected. (2) If the induced voltage exceeds an arbitrarily set reference threshold voltage, it is determined to be “rotation”, and the main drive pulse P1 maintained in energy is output to the other pole O2 of the drive coil, and this procedure is repeated by a certain number of times as long as the stepping motor continues rotating. When the number of times reaches a predetermined number of times (PCD), the main drive pulse P1 downgraded by a rank in drive energy is output to the other pole (downgrade), and this procedure is repeated again. (3) If the induced voltage does not exceed the reference threshold voltage, it is determined to be “non-rotation”, and the correction drive pulse P2 having a larger drive energy is output to the same pole immediately to cause a forced rotation. At the time of next driving, a main drive pulse P1 having a larger energy than the main drive pulse P1 which has resulted in “no-rotation” by a rank is output to the other pole (upgrade), and the procedures in (1) to (3) described above are repeated.

The invention described in WO2005/119377 discloses a unit for comparatively discriminating the time-of-day when the induced signal is detected and the reference time-of-day in addition to the detection of the level of the induced signal when detecting the rotation of the stepping motor. If the induced signal is lower than a predetermined reference threshold voltage Vcomp after having rotated the stepping motor with a main drive pulse P11, the correction drive pulse P2 is supplied, and the subsequent main drive pulse P1 is changed to a main drive pulse P12 having a larger energy than that of the main drive pulse P11 for driving the stepping motor (upgrade). If the detected time-of-day of the rotation with the main drive pulse P12 is earlier than the reference time, the main drive pulse P12 is changed to the main drive pulse P11 (downgrade), so that the stepping motor is rotated with the main drive pulse P1 according to a load generated at the time of driving the stepping motor and hence the power consumption is reduced.

In the related art, there are electronic watches configured in such a manner that if an external alternating current (AC) magnetic field is detected, the drive pulse is set to a fixed drive pulse having a predetermined drive energy in order to achieve a stable rotation for driving the stepping motor. However, since these electronic watches are not configured to support an external direct current (DC) magnetic field, there arises a problem of occurrence of abnormal rotation of the stepping motor if there exists the external direct current magnetic field, and hence abnormal clocking operation of the hands or the like is resulted.

### SUMMARY OF THE INVENTION

It is an aspect of the present application to achieve a normal rotation of a stepping motor even in a direct current magnetic field while reducing power consumption.

According to another aspect of the application, there is provided a stepping motor control circuit including: a rotation detecting unit configured to detect an induced signal generated according to the state of rotation of a stepping motor; and a control unit configured to select any drive pulse from a plurality of drive pulses having different energy from each other according to the result of detection by the rotation detecting unit and controls the drive of the stepping motor with different polarities alternately with the selected drive pulses, wherein if the difference of the detected time points of the induced signals generated when driving the stepping motor with the drive pulses having the same energy and different polarities is not shorter than a predetermined time, the control unit changes the drive pulse to a drive pulse having a larger energy than that of the drive pulse and drives the stepping motor.

According to another aspect of the application, there is provided an analogue electronic watch includes the stepping motor configured to rotate time-of-day hands and a stepping motor control circuit configured to control a stepping motor and is characterized in that the stepping motor control circuits according to any one of the embodiments described above is employed as the stepping motor control circuit.

According to the stepping motor control circuit in the application, the normal rotation of the stepping motor is achieved while reducing the power consumption even in the direct current magnetic field.

According to the analogue electronic watch in the application, the normal rotation of the stepping motor is achieved while reducing the power consumption even in the direct current magnetic field, so that accurate clocking operation is enabled.

### BRIEF DESCRIPTION OF THE DRAWINGS

FIG. 1 is a block diagram showing a stepping motor control circuit and an analogue electronic watch according to an embodiment of the invention;

FIG. 2 is a drawing showing a configuration of a stepping motor used in the analogue electronic watch according to the embodiment of the invention;

FIG. 3 is a timing chart for explaining the actions of the stepping motor control circuit and the analogue electronic watch according to the embodiment of the invention;

FIG. 4 is a flowchart showing the actions of the stepping motor control circuit and the analogue electronic watch according to the embodiment of the invention; and

FIG. 5 is a flowchart showing the actions of the stepping motor control circuit and the analogue electronic watch according to the embodiment of the invention.

### DESCRIPTION OF THE PREFERRED EMBODIMENTS

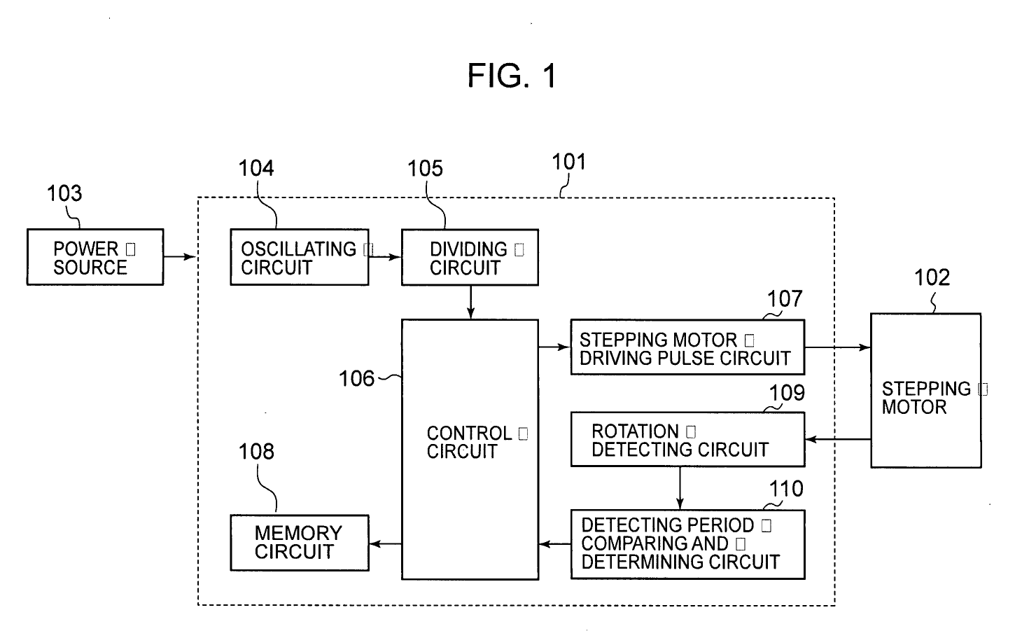

FIG. 1 is a block diagram of an analogue electronic watch using a stepping motor control circuit according to an embodiment of the invention, and shows an example of an analogue electronic wrist watch.

In FIG. 1, the analogue electronic watch includes a stepping motor control circuit 101, a stepping motor 102 the rotation of which is controlled by the stepping motor control circuit 101 to rotate time-of-day hands, a calendar mechanism (not shown), and so on, and a power source 103 such as a battery for supplying a drive power to circuit components such as the stepping motor control circuit 101 or the stepping motor 102.

The stepping motor control circuit 101 includes an oscillation circuit 104 configured to generate signals of a predetermined frequency, a frequency divider circuit 105 configured to divide the frequency of the signals generated by the oscillation circuit 104 and generate a clock signal which serves as a reference when counting the time, a control circuit 106 configured to make control such as control of respective electronic circuit components which constitute the electronic watch or control to change a drive pulse, a stepping motor drive pulse circuit 107 configured to select the drive pulse for rotating the motor on the basis of a control signal from the control circuit 106 and output the same to the stepping motor 102, a rotation detection circuit 109 configured to detect an induced signal VRs which indicates the state of rotation from the stepping motor 102 during a predetermined detection period, a detection time-of-day determination circuit 110 configured to determine the time-of-day if the rotation detection circuit 109 detects the induced signal VRs which exceeds a predetermined reference threshold voltage Vcomp for the first time, and a memory circuit 108 configured to store information on the time-of-day that the detection time-of-day determination circuit 110 determines and so on.

The rotation detection circuit 109 is configured on the basis of the same principle as the rotation detection circuit described in JP-B-61-15385, and is configured to detect whether or not the induced signal VRs generated due to the free oscillations immediately after the driving of the stepping motor 102 in a predetermined detection period and, every time when the induced signal VRs exceeding the reference threshold voltage Vcomp is detected, notify the same to the detection time-of-day determination circuit 110.

The detection time-of-day determination circuit 110 determines the time-of-day when the rotation detection circuit 109 detects the induced signal VRs which exceeds the predetermined reference threshold voltage Vcomp for the first time. The control circuit 106 performs a drive pulse switching control (pulse control) on the basis of the presence or absence of generation and the time-of-day of generation of the induced signal VRs exceeding the predetermined reference threshold voltage Vcomp for the first time obtained as a result of determination by the detection time-of-day determination circuit 110, as described later.

Information on a plurality of ranks of main drive pulses, correction drive pulses, and fixed pulses having energies different from each other provided in the stepping motor control circuit 101 in advance is stored in the memory circuit 108 in advance, and information on the time-of-day of generation of the induced signal VRs exceeding the reference threshold voltage Vcomp determined by the detection time-of-day determination circuit 110 is stored therein.

The oscillation circuit 104 and the frequency divider circuit 105 constitute a signal generating unit. The memory circuit 108 constitutes a memory unit. The rotation detection circuit 109 and the detection time-of-day determination circuit 110 constitute a rotation detecting unit. The oscillation circuit 104, the frequency divider circuit 105, the control circuit 106, the stepping motor drive pulse circuit 107, and the memory circuit 108 constitute a control unit.

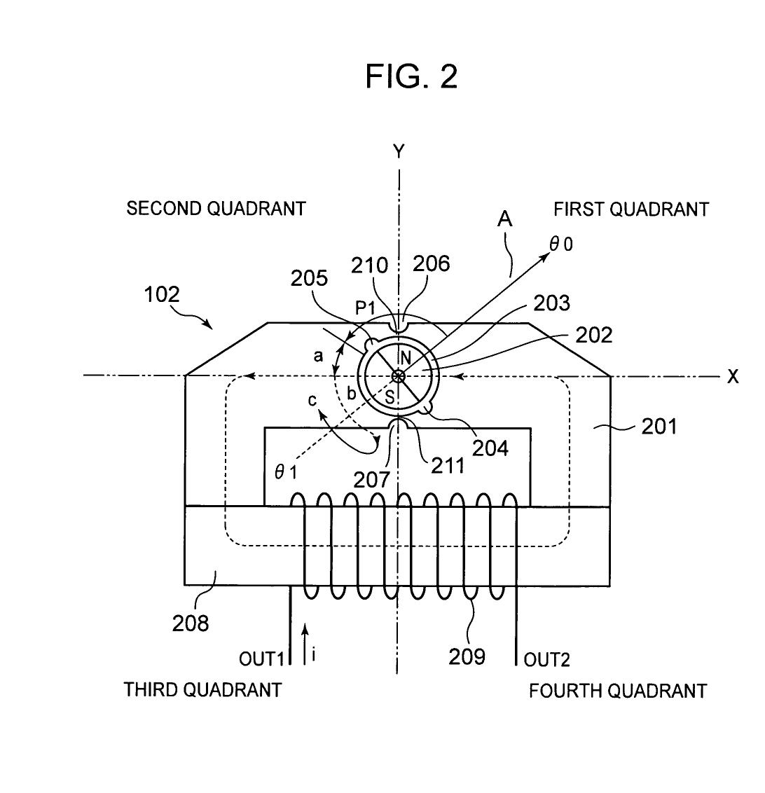

FIG. 2 is a configuration drawing of the stepping motor 102 which is used in this embodiment of the invention, and shows an example of the two-pole PM stepping motor which is generally used in the analogue electronic watch.

In FIG. 2, the stepping motor 102 includes a stator 201 having a rotor storage through hole 203, a rotor 202 disposed in the rotor storage through hole 203 so as to be capable of rotating therein, a magnetic core 208 joined to the stator 201, and a drive coil 209 wound around the magnetic core 208. If the stepping motor 102 is used in the analogue electronic watch, the stator 201 and the magnetic core 208 are fixed to a base panel (not shown) with screws or caulking (not shown) and are joined to each other. The drive coil 209 has a first terminal OUT1 and a second terminal OUT2.

The rotor 202 is magnetized in two polarities (S-pole and N-pole). A plurality of (two in this embodiment) notched portions (outer notches) 206 and 207 are provided on outer end portions of the stator 201 formed of a magnetic material at positions opposing to each other with the intermediary of the rotor storage through hole 203. Provided between the respective outer notches 206 and 207 and the rotor storage through hole 203 are saturable portions 210 and 211.

The saturable portions 210 and 211 are configured not to be magnetically saturated by a magnetic flux of the rotor 202 and to be magnetically saturated when the drive coil 209 is excited so that a magnetic resistance is increased. The rotor storage through hole 203 is formed into a circular hole shape having semicircular notched portions (inner notches) 204 and 205 integrally formed at opposed portions of the through hole having a circular contour.

The notched portions 204 and 205 constitute positioning portions for fixing the stop position of the rotor 202. In a state in which the drive coil 209 is not excited, the rotor 202 is stably stopped at a position corresponding to the above-described positioning portions, in other words, at a position (position at an angle of θ0) where the direction of an axis of magnetic pole A of the rotor 202 extends orthogonally to a segment connecting the notched portions 204 and 205 as shown in FIG. 2. An XY coordinate space extending around an axis of rotation of the rotor 202 as a center is divided into four quadrants (first to fourth quadrants).

If the drive pulse of a first polarity (for example, positive polarity on the first terminal OUT1 side and negative polarity on the second terminal OUT2 side) of a rectangular wave is supplied from the stepping motor drive pulse circuit 107 between terminals OUT1 and OUT 2 of the drive coil 209 and a current i is flowed in the direction indicated by an arrow in FIG. 2, a magnetic flux in the direction indicated by a broken line is generated in the stator 201. Accordingly, the saturable portions 210 and 211 are saturated and the magnetic resistance is increased, and then the rotor 202 rotates in a direction indicated by an arrow in FIG. 2 by 180° by a mutual action between a magnetic pole generated in the stator 201 and a magnetic pole of the rotor 202, and the axis of magnetic pole A stops stably at a position at an angle of θ1. The direction of rotation (counterclockwise rotation in FIG. 2) for causing the stepping motor 102 to rotate and putting the same into a normal action (the movement of the time-of-day hands because the watch in this embodiment is an analogue electronic watch) is defined to be a normal direction and the reverse direction (clockwise direction) is defined to be a reverse direction.

If the drive pulse of a second polarity different from the first polarity (negative polarity on the first terminal OUT1 side and positive polarity on the second terminal OUT2 side to achieve the reverse polarities from the above-described driving) of a rectangular wave is supplied from the stepping motor drive pulse circuit 107 between the terminals OUT1 and OUT2 of the drive coil 209 and a current is flowed in the opposite direction from the direction indicated by an arrow i in FIG. 2, a magnetic flux in the opposite direction from the direction indicated by a broken line is generated in the stator 201. Accordingly, the saturable portions 210 and 211 are saturated first, and then the rotor 202 rotates in the same direction (normal direction) as that described above by 180° by the mutual action between the magnetic pole generated in the stator 201 and the magnetic pole of the rotor 202, and the axis of magnetic pole A stops stably at a position at an angle of θ0.

In this manner, by supplying the signals having different polarities (alternating signals) alternately to the drive coil 209 from then onward, the action is repeatedly performed, so that the rotor 202 is rotated continuously in the direction indicated by an arrow by 180° each.

In this embodiment, a plurality of types of main drive pulses P11 to P1nmax having different drive energies from each other and a fixed drive pulse P3 having a larger drive energy than that of the main drive pulse P1nmax having the largest drive energy are used as the drive pulses, as described later. Here, as the fixed drive pulse P3, a correction drive pulse P2 which is a drive pulse for forcedly rotating the stepping motor 102 when the stepping motor 102 cannot be rotated with the main drive pulse P1 is used. By using the correction drive pulse P2 as the fixed drive pulse P3, the number of types of the drive pulses may be reduced. As the magnitude of the drive energy of the main drive pulse P1 (pulse rank), P11 is the minimum, and P1nmax is the maximum.

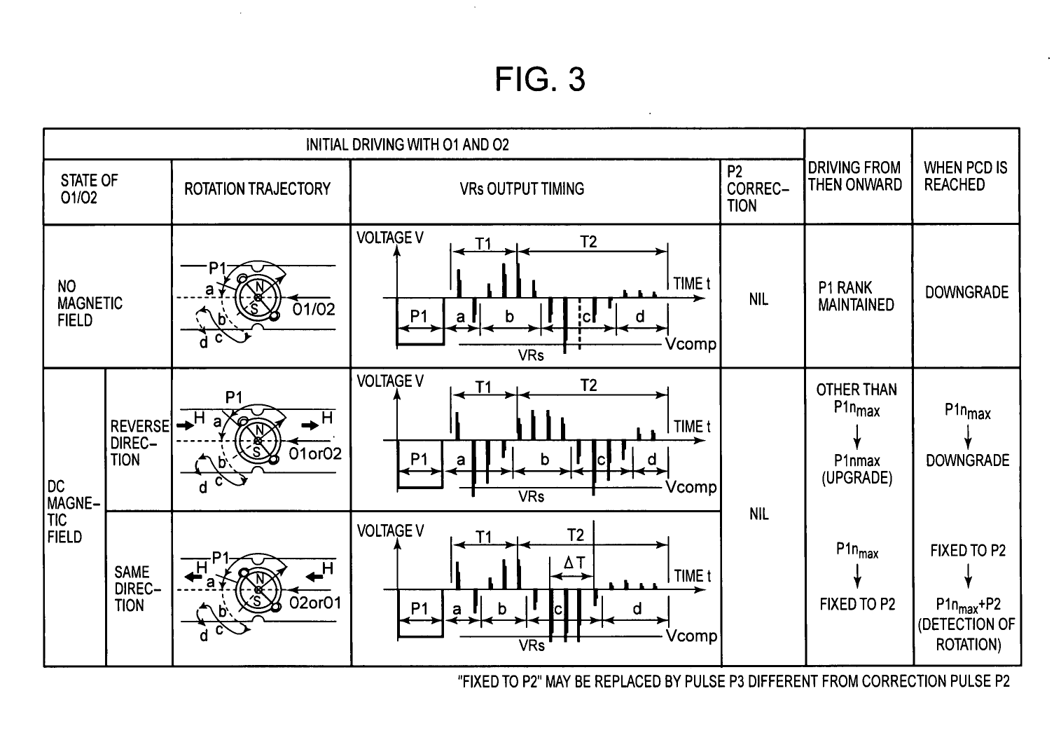

FIG. 3 is a timing chart for explaining the influence of a direct current magnetic field H when the stepping motor 102 is driven with the main drive pulse P1, showing also the state of the direct current magnetic field H, the trajectory of rotation of the rotor 202, the timing of output of the induced signal VRs when driven with the main drive pulse P1, presence or absence of the drive with the correction drive pulse P2 immediately after the driving with the main drive pulse P1, the control of the change of the drive pulse from the driving with the main drive pulse P1 onward (pulse control), and the pulse control to change the main drive pulse P1 to a main drive pulse having a smaller energy (downgrade) when the driving is continuously achieved by a predetermined number of times (PCD) with the main drive pulse having the same energy.

The reference sign P1 designates the main drive pulse P1 and also designates a period in which the rotor 202 is rotated with the main drive pulse P1. Reference signs “a” to “d” designate areas which indicate the position of rotation of the rotor 202 due to the free oscillations after having stopped the driving with the main drive pulse P1.

A predetermined time immediately after the drive with the main drive pulse P1 is a mask period T1, and a predetermined time after the mask period T1 is a detection period T2. The mask period T1 is a period in which the rotation detection circuit 109 does not detect the induced signal VRs, and the detection period T2 is a period in which the rotation detection circuit 109 detects the induced signal VRs exceeding the reference threshold voltage Vcomp. The mask period T1 is a period for enabling accurate detection of the induced signal VRs without causing the noise generated by the rotation of the stepping motor 102 to affect the detection of the induced signal VRs.

When the XY-coordinate space where the main magnetic pole A of the rotor 202 is situated by its rotation is divided into first to fourth quadrants about the rotor 202, the areas a to d as a rotation free oscillation areas of the stepping motor 102 can be expressed as follows. In other words, the area a is an area in which the rotor 202 rotates in the normal direction in the second quadrant, the area b is an area in which the rotor 202 firstly rotates in the normal direction in the third quadrant, the area c is an area in which the rotor 202 rotates in the reverse direction in the third quadrant, and the area d is an area in which the rotor 202 rotates for the second time in the normal direction in the third quadrant.

The reference threshold voltage Vcomp is a reference threshold voltage for determining the voltage level of the induced signal VRs generating in the stepping motor 102 for determining the state of rotation of the stepping motor 102. The reference threshold voltage Vcomp is set in such a manner that the induced signal VRs exceeds the reference threshold voltage Vcomp when the rotor 202 performs a certain fast action as in the case where the stepping motor 102 rotates, and the induced signal VRs does not exceed the reference threshold voltage Vcomp when the rotor 202 does not perform the certain fast action as in the case where the stepping motor 102 does not rotate.

In the description given below, a case where an induced signal VRsmax in the detection period T2 exceeds the reference threshold voltage Vcomp is designated as “1”, and a case where the induced signal VRsmax in the detection period T2 does not exceed the reference threshold voltage Vcomp is designated as “0”. Since the mask period T1 is a period not used for determination of the state of rotation, whether or not the induced signal VRsmax generated in the mask period T1 exceeds the reference threshold voltage Vcomp has no relationship with the state of rotation and hence whether it is “1” or “0” has no meaning. Therefore, it is expressed as “1/0”.

In the driving with the main drive pulse P1nmax of the maximum drive energy, if there is no reserve drive energy, the drive pulse is switched to the fixed drive pulse P3 having a drive energy exceeding the main drive pulse P1nmax for the driving. However, in the example shown in FIG. 3, the correction drive pulse P2 is used as the fixed drive pulse P3 for not increasing the number of types of the drive pulses as described above. By using the fixed drive pulse P3 having a larger drive energy than that of the main drive pulse P1nmax and smaller than that of the correction drive pulse P2 as the fixed drive pulse, power saving is enabled.

FIG. 3 shows (1) a case where the direct current magnetic field H does not exist and the stepping motor is rotated with a reserve drive energy (no magnetic field), (2) a case where the eternal direct current magnetic field H exists in the direction opposite from the driving magnetic field generated by supplying the drive pulse between the first terminal OUT1 (O1) and the second terminal OUT2 (O2) (the direct current magnetic field, the reverse direction), and (3) a case where the eternal direct current magnetic field H exists in the same direction as the driving magnetic field generated by supplying the drive pulse between the first terminal OUT1 (O1) and the second terminal OUT2 (O2) (the direct current magnetic field, the same direction) in sequence from the top.

The direct current magnetic field H affects the induced signal VRs so as to downgrade (weaken) the level of the induced signal VRs or shift the time-of-day of generation thereof. For example, as shown in FIG. 3, if the direct current magnetic field H and the driving magnetic field exist in the same direction, the induced signal VRs is shifted so as to be generated earlier than the case where there is no direct current magnetic field H. In contrast, if the direct current magnetic field H is opposite from the direction of the driving magnetic field, the induced signal VRs is shifted so as to be generated later than the case where there is no direct current magnetic field H. In this embodiment, the pulse control is performed by detecting existence of the direct current magnetic field H using the fact that the time-of-day of generation of the induced signal VRs changes according to the directions of the direct current magnetic field H and the driving magnetic field.

The detection time-of-day determination circuit 110 determines the time-of-day when the induced signal VRs which exceeds the reference threshold voltage Vcomp for the first time is detected in the detection period T2.

If the difference between the detected time of the induced signal VRs when driven by supplying the drive pulse of the first polarity to the terminals OUT1 and OUT2 and the detected time of the induced signal VRs when driven by supplying the drive pulse of the second polarity, which is the opposite polarity from the first polarity, to the terminals OUT1 and OUT2 subsequently exceeds a predetermined value, the control circuit 106 determines that the direct current magnetic field H of a predetermined level or higher which may affect the driving of the stepping motor 102 exists, and performs the pulse control of the drive pulse.

For example, if it is determined that the difference of the detected times exceeds the predetermined value, and if the drive pulse at that time is the main drive pulse P1 other than the main drive pulse P1nmax having the maximum energy, the control circuit 106 changes the main drive pulse to the main drive pulse P1nmax and rotates the stepping motor 102. In contrast, if it is determined that the difference of the detected times exceeds the predetermined value, and if the drive pulse at that time is the main drive pulse P1nmax, the control circuit 106 changes the main drive pulse to the fixed drive pulse P3 (the correction drive pulse P2 in this embodiment) and rotates the stepping motor 102.

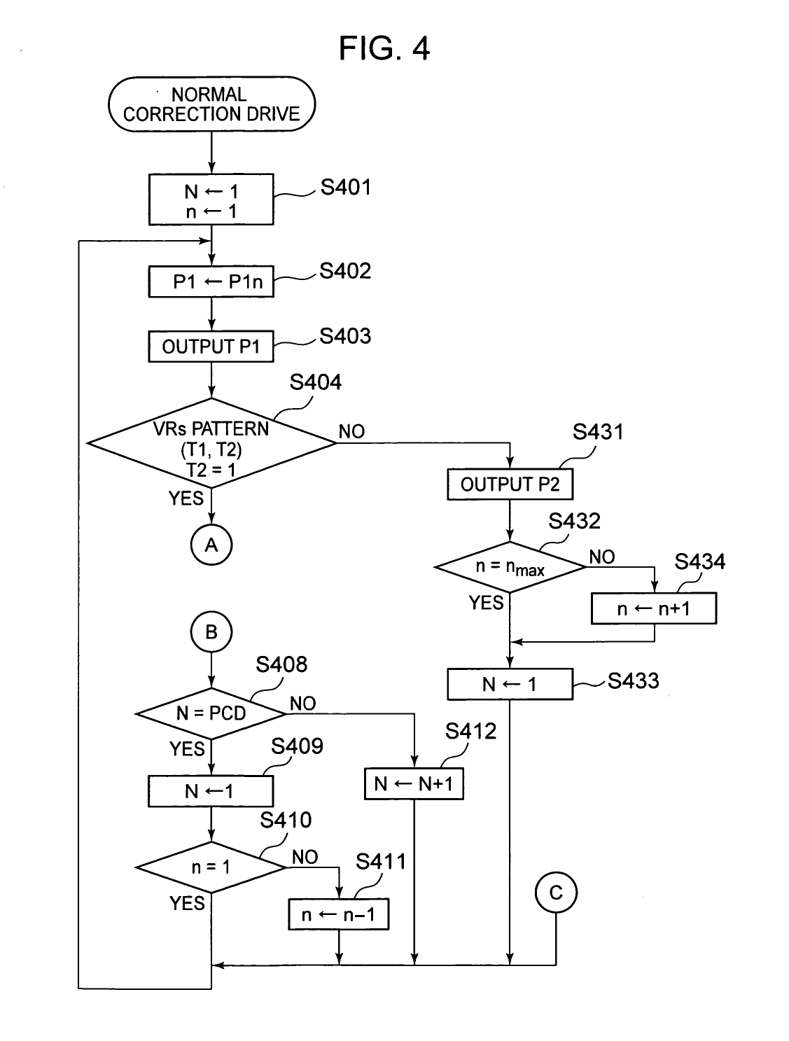

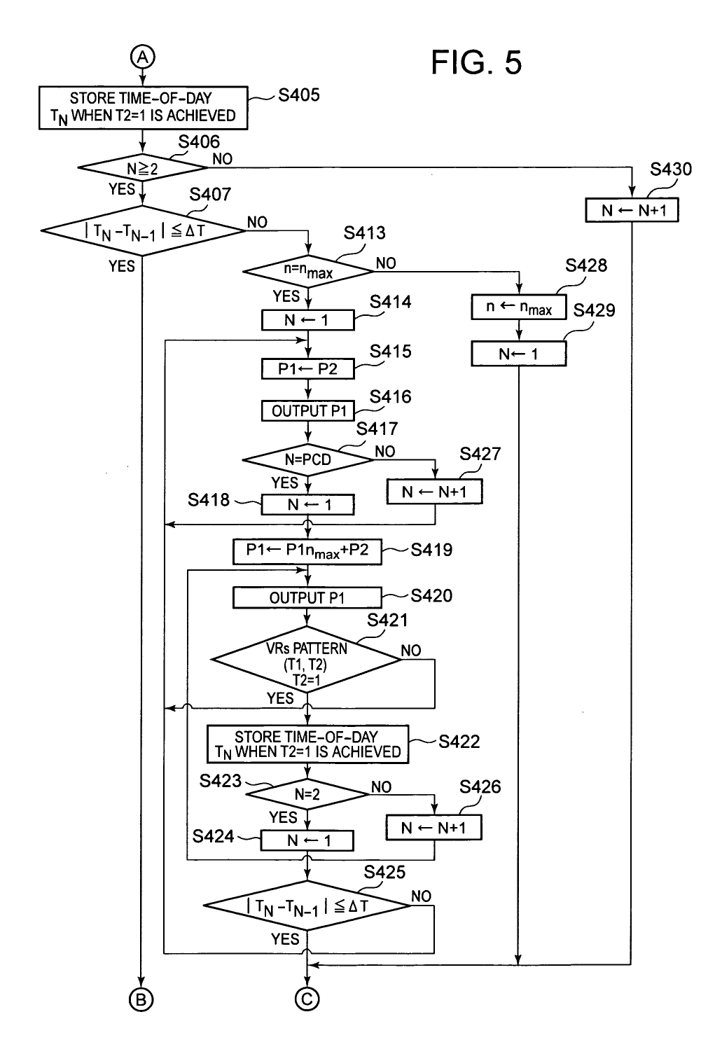

FIG. 4 and FIG. 5 are flowcharts showing the actions of the stepping motor control circuit and the analogue electronic watch according to embodiment of the invention.

The meanings of the respective reference numerals in FIG. 4 and FIG. 5 are as follows. The reference sign P1 designates the main drive pulse which drives the stepping motor 102 at the time of normal driving action (at the time of normal correction driving).

The main drive pulse P1 at the time of normal correction driving is a main drive pulse selected from the plurality of types of the main drive pulses P11 to P1nmax according to the drive pulse selecting process, described later. Reference numeral “n” is a pulse rank of the main drive pulse P1 at the time of the normal correction driving, and there are a plurality of types of ranks from the minimum drive energy 1 to the maximum drive energy nmax.

Reference sign P2 is a correction drive pulse at the time of the normal correction driving, and has a drive energy larger than that of the main drive pulse P1nmax having the maximum energy. In this embodiment, the correction drive pulse P2 is commonly used also as the fixed drive pulse P3.

Information on the main drive pulses P11 to P1nmax, the correction drive pulse P2, and the fixed drive pulse P3 is stored in the memory circuit 108.

The reference sign N is a number of times of repetition of driving driven continuously with the drive pulse having the same energy, and takes a value from the minimum value 1 to a predetermined value (PCD).

Referring now to FIG. 1 to FIG. 5, the actions of the stepping motor control circuit and the analogue electronic watch according to the embodiment of the invention will be described in detail.

The oscillation circuit 104 generates a reference clock signal of a predetermined frequency, and the frequency divider circuit 105 divides the signal generated by the oscillation circuit 104 and outputs a clock signal as a reference of time counting to the control circuit 106.

The control circuit 106 counts the clock signal and performs a time counting action. Then, the control circuit 106 firstly sets the rank n of the main drive pulse P1 to a minimum rank 1 and sets the number times of repetition N of the drive pulse to “1” for performing the pulse selecting process in sequence from the main drive pulse P1 having the smallest energy (Step S401 in FIG. 4), and outputs the control signal so as to rotate the stepping motor 102 with the main drive pulse P11 having the minimum energy (Steps S402, S403).

The stepping motor drive pulse circuit 107 rotates the stepping motor 102 with the main drive pulse P11 in response to the control signal from the control circuit 106. The stepping motor 102 is rotated with the main drive pulse P11 and then rotates the time-of-day hands and the like, not shown. Accordingly, when the stepping motor 102 is normally rotated, the current time-of-day and the like is displayed by the time-of-day hands.

The rotation detection circuit 109 outputs detection signals to the detection time-of-day determination circuit 110 every time when the induced signal VRs of the stepping motor 102 exceeding the predetermined reference threshold voltage Vcomp in the detection period T2 immediately after the driving with the drive pulse is detected. The detection time-of-day determination circuit 110 determines the detected time of the induced signal VRsmax exceeding the reference threshold voltage Vcomp firstly in the detection period T2 on the basis of the detected signal from the rotation detection circuit 109, and notifies the determination value “1” or “0” in the detection period T2 and the detected time to the control circuit 106.

The control circuit 106 determines the state of rotation whether or not the stepping motor is rotated on the basis of the determination value from the detection time-of-day determination circuit 110 (Step S404).

The control circuit 106 determines that the stepping motor 102 is rotated if the determination value in the detection period T2 is “1” in the process step S404, that is, if the pattern of the induced signal VRs (T1, T2) is (1/0, 1).

If the determination value in the detection period T2 is “1” in the process step S404, the control circuit 106 stores a detected time T_{N} of the induced signal VRs in the memory circuit 108 (Step S405 in FIG. 5).

Subsequently, if the number of times of repetition at this time is two or more (Step S406), at least two or more of the detected times when driven with the drive pulses having the same drive energy and different polarities alternately are stored in the memory circuit 108. Therefore, the control circuit 106 reads out the detected time T_{N} obtained this time and a detected time T_{N-1} obtained previously from the memory circuit 108, and calculates the difference between the detected time T_{N} and the detected time T_{N-1} (T_{N}−T_{N-1}).

When the difference of the detected times (T_{N}−T_{N-1}) is not longer than a predetermined value ΔT (for example, 3 ms) (Step S407) and the number of times of repetition N is the predetermined number of times (PCD) (Step S408), the control circuit 106 resets the number of times of repetition N to “1” (Step S409), and if the rank n of the main drive pulse P1 is “1”, the main drive pulse P1 cannot be downgraded, so that the procedure goes back to the process step S402 without changing the main drive pulse P1 (Step S410).

If the control circuit 106 determines that the rank n of the main drive pulse P1 is not “1” in the process step S410, the main drive pulse P1 is downgraded by a rank, and then the procedure goes back to the process step S402 (Step S411).

If the control circuit 106 determines that the number of times of repetition N is not the predetermined number of times (PCD) in the process step S408, the number of times of repetition N is incremented by “1”, and then the procedure goes back to the process step S402 (Step S412).

If the determination value of the detection period T2 is not “1” in the process step S404, the control circuit 106 determines that the stepping motor 102 cannot be rotated, and hence controls the stepping motor drive pulse circuit 107 so as to forcedly rotate the stepping motor 102 with the correction drive pulse P2 (Step S431). In response to the control of the control circuit 106, the stepping motor drive pulse circuit 107 drives the stepping motor 102 with the correction drive pulse P2, whereby the stepping motor 102 is rotated.

Subsequently, if the rank n of the main drive pulse P1 at this time is the maximum rank nmax (Step S432), the control circuit 106 resets the number of times of repetition N to “1” (Step S433) and goes back to the process step S402 without changing the main drive pulse P1. If the control circuit 106 determines that the rank n of the main drive pulse P1 is not the maximum rank nmax in the process step S432, the rank of the main drive pulse P1 is upgraded by a rank, and then the procedure goes to the process step S433 (Step S434). In this manner, the pulse control when the direct current magnetic field H having strength not smaller than the predetermined strength does not exist is performed.

In contrast, if the difference of the detected times (T_{N}−T_{N-1}) is longer than the predetermined period ΔT in process step S407, the control circuit 106 determines that there exists the external direct current magnetic field H having a strength not lower than the predetermined strength, and if the rank n of the main drive pulse P1 is the maximum rank nmax (Step S413), resets the number of times of repetition N to “1” (Step S414), and controls the stepping motor drive pulse circuit 107 so as to change the drive pulse to the correction drive pulse P2 as the fixed drive pulse and drives the stepping motor 102 (Steps S415, S416).

In this manner, if the difference of the detected times (T_{N}−T_{N-1}) of the induced signal VRs if the drive pulses having the same energy and different polarities are supplied to the terminals OUT1 and OUT2 for driving exceeds the predetermined period ΔT, the drive pulse is changed to a drive pulse having a larger energy and drives the stepping motor. In response to the control of the control circuit 106, the stepping motor drive pulse circuit 107 drives the stepping motor 102 with the correction drive pulse P2, whereby the stepping motor 102 rotates.

When the number of times of repetition N is a predetermined number of times (PCD) (Step S417), the control circuit 106 resets the number of times of repetition N to “1” (Step S418), and then controls the stepping motor drive pulse circuit 107 so as to drive the stepping motor 102 continuously with the main drive pulse P1nmax in the maximum rank and the correction drive pulse P2 having the same polarity as the main drive pulse P1nmax (Steps S419, S420). In response to the control of the control circuit 106, the stepping motor drive pulse circuit 107 drives the stepping motor 102 with the main drive pulse P1nmax, then, subsequently, drives the stepping motor 102 with the correction drive pulse P2 having the same polarity as the main drive pulse P1nmax. Accordingly, even though the stepping motor 102 cannot be rotated when the drive pulse is changed from the fixed drive pulse to the main drive pulse P1nmax, the stepping motor 102 can be rotated with the correction drive pulse P2, so that resulting in non-rotation is prevented even though the drive pulse is changed to a drive pulse having a smaller energy.

The rotation detection circuit 109 detects the induced signal VRs generated by the stepping motor 102 driven with the main drive pulse P1nmax in the process step S420, and the detection time-of-day determination circuit 110 determines the detected time of the induced signal VRs.

If the control circuit 106 determines that the rotation detection circuit 109 detects the induced signal VRs having a determination value “1” in the detection period T2 (that is, the pattern is (1/0, 1) (Step S421), the detected time T_{N} of the first induced signal VRs is stored in the memory circuit 108 (Step S422).

If the number of times of repetition N is “2” (Step S423), the control circuit 106 resets the number of times of repetition N to “1” (Step S424). If the difference between the detected time T_{N} of this time and the detected time T_{N-1} of the previous time stored in the memory circuit 108 is not larger than the predetermined time ΔT, the control circuit 106 determines that the stepping motor 102 can be stably rotated even after having been downgraded, and hence goes back to the process step S402 to perform the normal correction driving (Step S425). In this manner, if the difference between the detected time of the induced signal VRs when driven by supplying the drive pulse of the first polarity to the terminals OUT1 and OUT2 and the detected time of the induced signal VRs when driven by supplying the drive pulse of the second polarity, which is the opposite polarity from the first polarity, to the terminals OUT1 and OUT2 subsequently is not larger than the predetermined value ΔT, the control circuit 106 determines that the stable driving is possible, and hence returns back to the normal correction driving.

In this manner, if the drive pulse is downgraded from the correction drive pulse P2 as a sort of the fixed drive pulse to the main drive pulse P1, once each of the driving with the drive pulse having the first polarity and the driving with the drive pulse having the second polarity following the driving with the drive pulse having the first polarity are achieved with the maximum main drive pulse P1nmax and the correction drive pulse P2 having the same polarity, respectively. If the difference of the detected time of the first induced signal VRs exceeding the reference threshold voltage Vcomp detected by the driving with the main drive pulse P1nmax having the first polarity and the main drive pulse P1nmax having the second polarity is returned back into the predetermined time ΔT, the drive pulse is returned from the correction drive pulse P2 as the fixed drive pulse to the main drive pulse P1nmax. Accordingly, the drive pulse can be changed while preventing occurrence of the event in which the stepping motor 102 is brought into the non-rotating state due to the change of the drive pulse.

If the difference between the detected time T_{N} of this time and the detected time T_{N-1} of the previous time is not longer than the predetermined time ΔT in the process step S425, the control circuit 106 determines that the stable rotation of the stepping motor 102 cannot be ensured if downgraded, so that the procedure goes back to the process step S415.

If the number of times of repetition N is not “2” or more in the process step S423, the control circuit 106 increments the number of times of repetition N by “1”, and then the procedure goes to back the process step S420 (Step S426).

If the control circuit 106 determines that the determination value in the detection period T2 in the process step S421 is not “1”, the procedure goes back to the process step S415.

If the control circuit 106 determines that the number of times of repetition N does not reach the predetermined number of times (PCD) in the process step S417, the number of times of repetition N is incremented by “1” (step S427), and then the procedure goes back to the process step S415. In this manner, if the main drive pulse P1 is the main drive pulse P1nmax, the stepping motor 102 is driven with the fixed drive pulse during the predetermined number of times (PCD).

If the rank n of the main drive pulse P1 is not the maximum rank nmax in the process step S413, the control circuit 106 sets the rank n to the maximum rank nmax (Step S428), and resets the number of times of repetition N to “1” (Step S429), then goes back to the process step S402. In this manner, if the main drive pulse P1 is not the main drive pulse P1nmax of the maximum rank, the main drive pulse P1 is upgraded at a burst to the main drive pulse P1nmax, the stable driving can be performed even though the direct current magnetic field H exists.

If the number of times of repetition N is not “2” or more in the process step S406, the control circuit 106 increments the number of times of repetition N by “1” (Step S430), and then the procedure goes back to the process step S402.

As described thus far, the stepping motor control circuit according to the embodiment includes the rotation detection circuit 109 configured to detect the induced signal VRs generated according to the state of rotation of the stepping motor 102, and the control unit configured to select the any one of the plurality of drive pulses having different energies from each other according to the result of detection by the rotation detection circuit 109 and controls the drive of the stepping motor 102 alternately with the selected drive pulses having different polarities from each other. If the difference of the detected times of the induced signals VRs generated when rotated with the drive pulses having the same energy and different polarities is not shorter than the predetermined time, the control unit changes the drive pulse to the drive pulse having a larger energy than that of the drive pulse described above and drives the stepping motor 102.

Therefore, the stepping motor 102 can be rotated normally and stably even in the direct current magnetic field H of a predetermined level or higher while reducing the power consumption. It is not necessary to provide a complex detection circuit, and hence a simple configuration is advantageously achieved.

According to the analogue electronic watch in this embodiment, the normal rotation of the stepping motor is achieved while reducing the power consumption even in the direct current magnetic field, so that the normal clocking operation is enabled.

In the embodiment described above, one segment T2 is used as the detection period. However, it is also possible to divide the detection period into a plurality of segments and perform the pulse control on the basis of the pattern of the induced signals VRs detected in the plurality of segments and exceeding the reference threshold voltage Vcomp.

In the embodiment described above, the energy of the respective main drive pulses is changed by differentiating the pulse width of the rectangular wave. However, the driving energy can be changed also by employing a comb-teeth wave as the pulse itself and changing the ON/OFF duty, or by changing the pulse voltage.

The example of the electronic watch has been described as an example of application of the stepping motor, the invention is applicable to electronic apparatuses in which a motor is used.

The stepping motor control circuit according to the invention may be applicable to various electronic instruments using the stepping motor.

The electronic watch according to the invention is applicable to various analogue electronic watches such as analogue electronic watches with calendar function, or chronograph watches.

What is claimed is:

1. A stepping motor control circuit comprising:
a rotation detecting unit configured to detect an induced signal generated according to the state of rotation of a stepping motor; and a control unit configured to select any drive pulse from a plurality of drive pulses having different energy from each other according to the result of detection by the rotation detecting unit and controls the drive of the stepping motor with different polarities alternately with the selected drive pulses,
wherein if the difference of the detected time points of the induced signals generated when driving the stepping motor with the drive pulses having the same energy and different polarities is not shorter than a predetermined time, the control unit changes the drive pulse to a drive pulse having a larger energy than that of the drive pulse and drives the stepping motor.

2. A stepping motor control circuit according to claim 1, wherein if the drive pulse before the change is a main drive pulse, the control unit changes the drive pulse to a main drive pulse having a larger energy than that of the main drive pulse and drives the stepping motor.

3. A stepping motor control circuit according to claim 1, wherein if the drive pulse before the change is the main drive pulse, the control unit changes the drive pulse to a main drive pulse having a maximum energy and drives the stepping motor.

4. A stepping motor control circuit according to claim 2, wherein if the drive pulse before the change is the main drive pulse, the control unit changes the drive pulse to a main drive pulse having a maximum energy and drives the stepping motor.

5. A stepping motor control circuit according to claim 1, wherein if the drive pulse before the change is the main drive pulse having the maximum energy, the control unit changes the drive pulse to a fixed drive pulse having a predetermined energy larger than the main drive pulse before the change and drives the stepping motor.

6. A stepping motor control circuit according to claim 2, wherein if the drive pulse before the change is the main drive pulse having the maximum energy, the control unit changes the drive pulse to a fixed drive pulse having a predetermined energy larger than the main drive pulse before the change and drives the stepping motor.

7. A stepping motor control circuit according to claim 3, wherein if the drive pulse before the change is the main drive pulse having the maximum energy, the control unit changes the drive pulse to a fixed drive pulse having a predetermined energy larger than the main drive pulse before the change and drives the stepping motor.

8. A stepping motor control circuit according to claim 4, wherein if the drive pulse before the change is the main drive pulse having the maximum energy, the control unit changes the drive pulse to a fixed drive pulse having a predetermined energy larger than the main drive pulse before the change and drives the stepping motor.

9. A stepping motor control circuit according to claim 5, wherein the fixed drive pulse is a correction drive pulse.

10. A stepping motor control circuit according to claim 6, wherein the fixed drive pulse is a correction drive pulse.

11. A stepping motor control circuit according to claim 7, wherein the fixed drive pulse is a correction drive pulse.

12. A stepping motor control circuit according to claim 8, wherein the fixed drive pulse is a correction drive pulse.

13. A stepping motor control circuit according to claim 1, wherein if the drive pulse before the change is the correction drive pulse, the control unit does not change the drive pulse.

14. A stepping motor control circuit according to claim 2, wherein if the drive pulse before the change is the correction drive pulse, the control unit does not change the drive pulse.

15. A stepping motor control circuit according to claim 3, wherein if the drive pulse before the change is the correction drive pulse, the control unit does not change the drive pulse.

16. A stepping motor control circuit according to claim 4, wherein if the drive pulse before the change is the correction drive pulse, the control unit does not change the drive pulse.

17. A stepping motor control circuit according to claim 5, wherein if the drive pulse before the change is the correction drive pulse, the control unit does not change the drive pulse.

18. A stepping motor control circuit according to claim 6, wherein if the drive pulse before the change is the correction drive pulse, the control unit does not change the drive pulse.

19. A stepping motor control circuit according to claim 1, wherein the control unit rotates the stepping motor by a predetermined number of times continuously with the fixed drive pulse having the predetermined energy larger than that of the main drive pulse having the maximum energy, then changes the drive pulse to the main drive pulse having the maximum energy and the correction drive pulse and drives the stepping motor by a plurality of times with different polarities, and, if the difference of the detected time points of the induced signals detected when driven by the plurality of times in different polarities with the main drive pulse having the maximum energy is within a predetermined period, changes the fixed drive pulse to the main drive pulse having the maximum energy and drives the stepping motor.

20. An analogue electronic watch having a stepping motor configured to rotate time-of-day hands, and a stepping motor control circuit configured to control the stepping motor,
wherein the stepping motor control circuit according to claim 1 is used as the stepping motor control circuit.
